(19) United States
(12) Patent Application Publication
(10) Pub. No.: US 2002/0024197 A1
(43) Pub. Date: Feb. 28, 2002

(54) Air bag module

(75) Inventors: David E. Thomas, North Branch, MI (US); Eric J. Baumbach, Sterling Heights, MI (US)

Correspondence Address: BREED TECHNOLOGIES, INC, PATENT DEPARTMENT, 7000 NINETEEN MILE ROAD, STERLING HEIGHTS, MI, 48314

(73) Assignee: Breed Automotive Technologies, Inc.

(21) Appl. No.: 09/934,222

(22) Filed: Aug. 21, 2001

Related U.S. Application Data
(60) Provisional application No. 60/229,009, filed on Aug. 30, 2000.

(51) Int. Cl. B60R 21/16

(52) U.S. Cl. 280/728.2; 280/728.1

(57) ABSTRACT

An air bag module (20) including: an air bag (90); a housing (22) formed of loosely interfitting upper (26) and lower (24) housing members, the air bag linked to at least one of the interfitting portions (32) of the upper housing member to provide an insulating barrier between the members.

### BACKGROUND AND SUMMARY OF THE INVENTION

This is a regularly filed utility patent application claiming priority of provisional patent application No. 60/229,009, filed Aug. 30, 2000. The present invention relates to an air bag module and in particular to a passenger side air bag module having a multipart housing, air bag and inflator.

It is an object of the present invention to provide an air bag module having a unique method of mounting the inflator to the housing.

The present invention comprises an air bag module comprising: an air bag; a housing formed of loosely interfitting upper and lower housing members, the air bag linked to at least one of interfitting portions of the upper housing member to provide an insulating barrier between the members. The lower housing member includes flexible tabs and the upper housing member including complementary flexible ear or plate-like portions to interfit with each tab.

Many other objects and purposes of the invention will be clear from the following detailed description of the drawings.

### BRIEF DESCRIPTION OF THE DRAWINGS

FIG. 1 is an assembly view of an air bag module incorporating the invention.

FIG. 2 is a cross-sectional view showing many features of the present invention.

FIG. 3 is a cross-sectional view showing first and second housing members snap fit together clamping an air bag therebetween.

FIG. 4 is another cross-sectional view showing an integral spring-like bridge formed in the upper housing member.

FIG. 5 is a partial isometric view of an air bag.

### DETAILED DESCRIPTION OF THE DRAWINGS

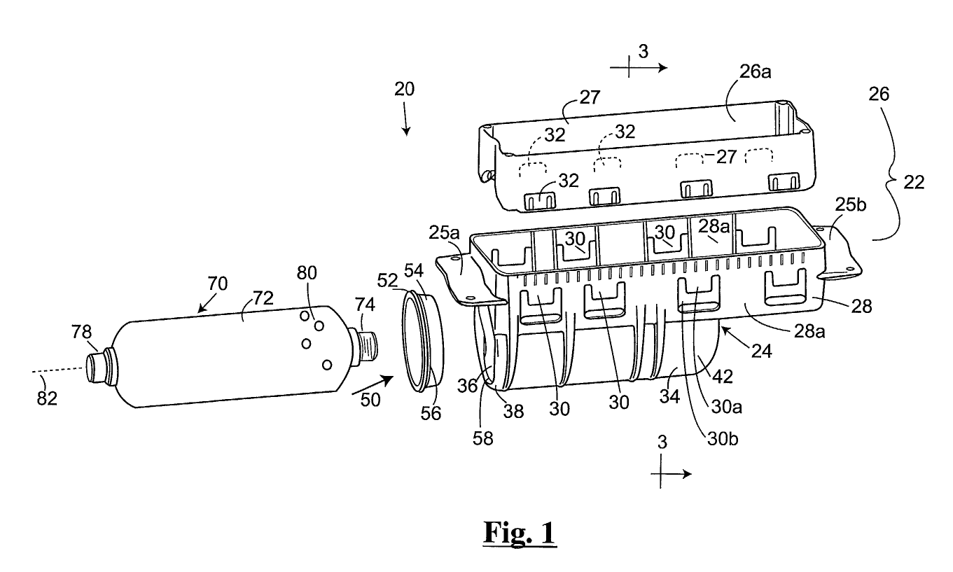

Reference is made to FIGS. 1-3, which illustrate an air bag module 20 comprising a multi-piece housing 22, including a lower housing member 24 and upper housing member 26. Preferably, the housing parts 24 and 26 are made of cast magnesium. The housing includes mounting flanges 25a and 25b so that the module can be mounted to a part of the vehicle, typically near the instrument panel. The lower housing member includes a hollow, upper rectangular portion 28 with a plurality of integrally formed first latching features 30 such as resilient tabs, which snap fit with complementary mating latching features 32 of the upper housing member 26. As can be seen, the illustrated embodiment utilizes four such features 30 and 32 on each side of the lower and upper housing members. The upper housing member is also hollow in construction and the ear-shaped latching features extend from side walls 27 thereof. As can be seen from FIGS. 1-3, the lower housing member includes a hollow cylindrical inflator compartment 34 having an opening 36 in end 38 and an opening 40 in opposing end 42. End 38 defines a shoulder 44. As can be seen from FIG. 1, the features 30 also include an opening 30b below each tab 30a. When the upper housing member 26 has been snapped in place in the lower housing member, the features 32 will be positioned loosely in a respective opening 30b. The air bag 90 and lining 98, which is received about each of the features 32, is of sufficient thickness to prevent the upper housing member from rattling in the lower housing member 24. Once snapped into place the tabs prevent the upper housing member from being moved out from the lower housing member.

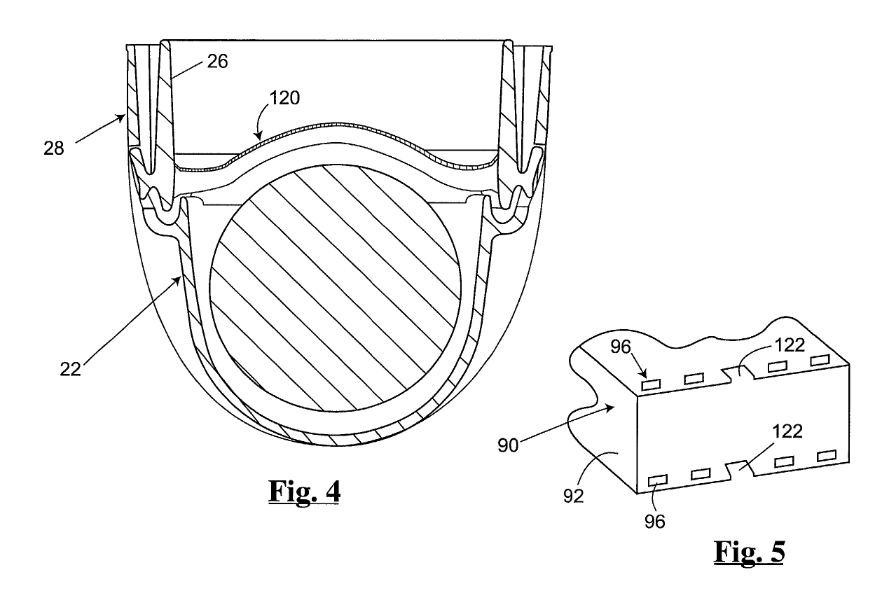

Reference is briefly made to FIG. 4, which shows another cross-sectional view of the mated housing 22. Also shown is a bridge 120 integrally formed in the upper housing member 26. The bridge is resilient and generates a reaction force to maintain the sides of the housing 22 in place and avoid bell-mouthing of the housing as the air bag inflates.

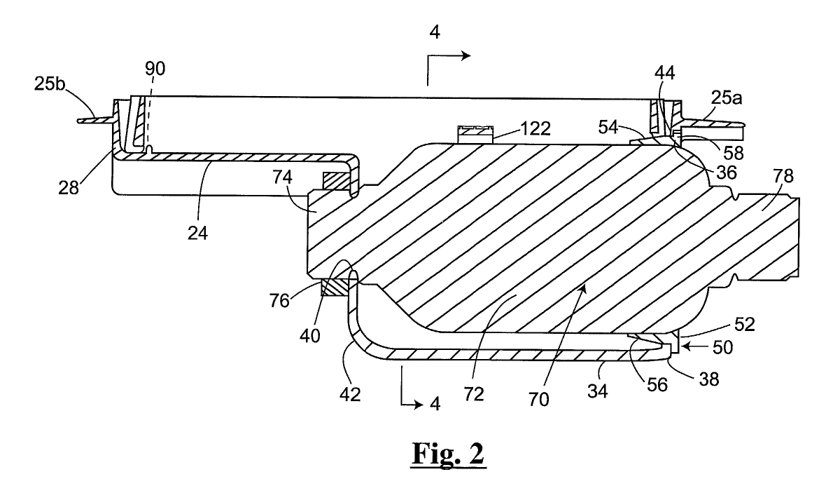

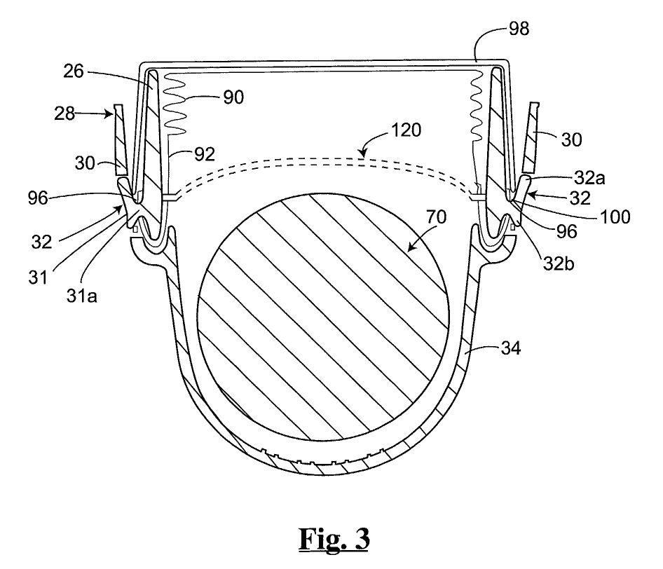

A plastic (generally PPA) sleeve 50 is received within opening 36. The sleeve is a hollow structure comprising an outer lip 52 and an extending tapered ring 54. Located at the underside of the lip 52 on the outer wall of the ring, is an annular groove 56, which snaps upon the annular wall 58, formed about opening 36. The module 20 also includes an inflator 70 having a cylindrical body 72 with a threaded fastener or stud 74 at one end. While not shown, the body is hollow and includes means for producing or releasing inflation gas using one of the many available technologies. FIG. 2 shows stud 74 received through opening 40 and secured thereto by a nut 76. The other end of the inflator includes an electrical connector 78 for connection to a control unit. As can be seen from FIG. 1, the inflator includes a plurality of exit ports 80 to communicate gas from the inflator 70 through the housing 22 to an air bag 90 (also see FIG. 3).

Reference is briefly made to FIG. 3, which is a cross-sectional view taken perpendicular to an axis 82 of the module 20. The locking features 30 and 32 are clearly shown snapped together. As can also be seen, an air bag 90 is clamped between the peripheral outer edge of housing member 26 and the inner peripheral edge of upper housing portion 28. The air bag 90 includes a neck 92, which is clamped between the housing members 24 (actually the upper housing portion 28) and 26. Situated about the neck is a plurality of openings 96, each of which is received about a corresponding snap feature 32 of the upper housing member 32. The ears 32a, b of each feature assist in holding the air bag to the housing. Each ear includes a root 31 and plate-like extension 31a. As illustrated, the air bag is shown folded and located within the open space 26a formed in the upper housing member 26. The air bag is maintained in this folded condition by a thin lining 98 of Tyvek or other material, which has a preferred tear region such as defined by a line of perforations (not shown). The lining also includes openings 100 enabling the lining to be secured about the locking features 32. It is envisioned that the air bag is first secured to the upper housing member and then the upper housing member is snapped into the lower housing member.

As can be seen from FIGS. 1 and 2, the sleeve 50 is snapped into the lower housing member 24 and then the inflator is slid into the sleeve 50 and into the housing and the fastener 74 secured in the housing. The body of the inflator is loosely received into the cylindrical interior wall of the sleeve. It has been shown that it is not necessary to effect a fluid tight seal between the sleeve 50 and the inflator 70, as most if not all of the inflation gas produced by the inflator 70 will exit the inflator and flow through the hollow mating portions 24 and 26 of the housing 22 into the air bag 90. In the preferred embodiment, the inside diameter of the sleeve is about 60.6 mm and the outside diameter of the inflator is about 60 mm.

Reference is briefly made to FIG. 5, which shows the neck portion 92 of the air bag. The openings 96 in each side of the neck are clearly visible. Additionally, if the bridge 120 is used each side of the neck includes a slot 122 to permit the neck to be placed in the upper member 26 of the housing and about the bridge 120. One of the slots 122 is shown in FIG. 2.

Many changes and modifications in the above-described embodiment of the invention can, of course, be carried out without departing from the scope thereof. Accordingly, that scope is intended to be limited only by the scope of the appended claims.

1. An air bag module (20) comprising:
an air bag (90);
a housing (22) formed of loosely interfitting upper (26) and lower (24) housing members, the air bag linked to at least one of the interfitting portions to provide an insulating barrier between the members.

2. The apparatus as defined in claim 1 wherein the lower housing member is adapted to receive an inflator for providing inflation gas to receive the air bag, which is mounted remote from the location of the inflator.

3. The apparatus as defined in claim 1 wherein the upper housing member includes an arcuate, resilient bridge linking opposing sides of the upper housing member.

4. The apparatus as defined in claim 1 wherein the lower housing member (24) including a plurality of first latching features (30) on opposing sides and the upper housing member (26) including a plurality of complementary mating latching features (32).

5. The apparatus as defined in claim 4 wherein each first latching feature (30) includes an integrally formed flexible tab attached only on one of its sides to adjacent parts of the lower housing member.

6. The apparatus as defined in claim 5 wherein at least one of the upper and the lower housing member is formed from a lightweight metal casting.

7. The apparatus as defined in claim 4 wherein the latching features of the upper housing member include a root portion (31) extending from an adjacent side of the upper housing member and a plate-like member (31 a) extending from the root portion.

8. The apparatus as defined in claim 7 wherein once fitted together each tab of the lower housing member fits between a side of the upper housing member and a corresponding plate-like member.

9. The apparatus as defined in claim 8 wherein the air bag includes a plurality of slots or openings (96) in a neck portion thereof and wherein each slot or opening is received about a corresponding plate-like member.

10. The apparatus as defined in claim 1 wherein the lower housing member (26) includes a hollow cylindrically shaped inflator compartment with an opening (36) at one end of the compartment through which the inflator can be slid therein.

11. The apparatus as defined in claim 1 wherein the upper housing member includes first means resiliently linking opposing sides of the upper housing member to prevent bell-mouthing thereof.

12. The apparatus as defined in claim 11 wherein the first means includes an arcuate, resilient bridge linking opposing sides of the upper housing member.

13. The apparatus as defined in claim 12 wherein the air bag includes opposing slots in a neck portion thereof enabling the air bag to be placed in the upper housing member and about the bridge.

14. The apparatus as defined in claim 13 including a lightweight, flexible tearable liner disposed about the top of the upper housing member, the liner including openings received about selective complementary mating latching features (32) in the upper housing member.
